(19) United States
(12) Patent Application Publication
(10) Pub. No.: US 2009/0066451 A1
(43) Pub. Date: Mar. 12, 2009

(54) Solenoid

(76) Inventors: Georg J. Scherer, Kirchheim (DE); Helmut J. Mang, Memmingen (DE)

Correspondence Address: JACOBSON HOLMAN PLLC, 400 SEVENTH STREET N.W., SUITE 600, WASHINGTON, DC, 20004, US

(21) Appl. No.: 12/232,086

(22) Filed: Sep. 10, 2008

(30) Foreign Application Priority Data
Sep. 11, 2007 (DE) 10 2007 043 046.0

(51) Int. Cl. H01F 7/08

(52) U.S. Cl. 335/270

(57) ABSTRACT

The invention refers to a solenoid, in particular for switching pressure controllers or pressure valves, comprising an armature movable in an armature space, and a coil which can be impinged by current, wherein this, when impinged by current, generates a magnetic field serving for moving the armature, and the armature space can be filled with oil, and wherein for deairing the armature space at least one deairing channel is provided.

The invention is characterised in that in the deairing channel at least one backflow-preventing element is provided which is permeable in the direction of deairing.

### BACKGROUND OF THE INVENTION

The invention refers to a solenoid, in particular for switching pressure controllers or pressure valves, comprising an armature movable in an armature space and a coil which can be impinged by current, wherein the coil generates a magnetic field serving for the movement the armature when impinged by current, and the armature space can be filled with oil, and wherein for deairing the armature space at least one deairing channel is provided.

With pressure valves it is necessary for preventing self-oscillations of the control pressure tat the armature space is filled preferably completely with oil in order to reach a hydraulic damping of the armature movement. In delivery condition the armature space is filled. It is known in the state of the art to carry out the filling of the armature through the openings of the not yet mounted adjusting pin for the adjustment of the armature. For that purpose on the coil form flange a spiral-shaped sealing is arranged for the deairing through which the air can escape when the armature space is filled. After that the sealing prevents the armature space from emptying.

Furthermore solutions are known where a completely sealed armature space is filled with oil by means of vacuum filling. This is expensive and needs a lot of effort in respect of installations and has technical disadvantages.

### BRIEF SUMMARY OF THE INVENTION

Coming from this state of the art it is an object of the invention to simplify the filling process of the armature space of a solenoid with oil.

The problem of the invention is solved by a solenoid, in particular for switching pressure controllers or pressure valves, comprising an armature movable in an armature space, and a coil which can be impinged by current, wherein the coil when impinged by current generates a magnetic field serving for the movement of the armature, and the armature space can be filled with oil, and wherein for deairing the armature space at least one deairing channel is provided which is characterised in that in the deairing channel at least one element is provided which is permeable in deairing direction and prevents backflow.

By this design of the solenoid according to the invention the deairing channel, on the one hand, may be opened now during filling in order to let escape still remaining air from the armature space, on the other hand, however, the backflow of oil or soilings is prevented. Thus not only the problem of the invention with respect to the deairing of the armature space is solved during the filling with oil, but at the same time also an oil reduction and an oil change of the filling is prevented. Furthermore another advantageous effect is reached, namely that because of this design which prevents backflow, it is also prevented that soilings so to say with a backflow can get in the armature space. By this solution it is thus guaranteed that in the armature space there is always unpolluted oil which cannot be soiled, either, by soilings from outside. In the state of the art this was the case as because of the partly open design it was still possible that soilings could get in the armature space. Thus, for example, in the design with the spiral-shaped sealing already a part of the soilings has been caught in the siphon, however, this solution could not exclude that still soilings could get in the armature space. Only with the solution in the state of the art of vacuum filling working with a lot of effort also soiling was prevented.

The element preventing backflow here fulfils essentially also the function of a nonreturn valve. This lets pass, for example in the direction of flow, that means in the direction of deairing, air and liquid, but is closed in the reverse direction.

An advantageous development of the invention suggests that the deairing channel is part of the coil form or is arranged in the deairing channel in the coil form itself. Here a space-saving arrangement and at the same time also an arrangement of the deairing channel which can be realised technically and mechanically easily is planned. By the arrangement of the deairing channel in the coil form or at the coil form it is possible to assemble the solenoid relatively space-saving altogether.

According to a modification of the invention it is possible here that the deairing channel is provided at or in the flange of the coil form or in or at the siphon which is connected to the flange. There also the deairing channel can be arranged without further required space, if necessary together with other components for the backflow-preventing element.

A development of the invention is given by the fact that the deairing channel is provided in the core which extends between coil form and armature. Here also a space-saving arrangement is possible so that also without any problems space can be made for the backflow-preventing element.

The invention is characterised according to a development also in that the backflow-preventing element is provided in the coil form and/or the flange and/or the core. Depending on which modification is chosen for the deairing channel as described before, the backflow-preventing element is then arranged accordingly.

Another aspect of the invention is given by the fact that the backflow-preventing element is provided as nonreturn valve. A nonreturn valve can here be constructed rather simply. It does not necessarily have to have a complicated design such, as it is known, for example, from plant engineering. As a nonreturn valve in the simplest embodiment it is provided according to the invention that it is designed as lip seal. The lip seal can be here arranged in the deairing channel in such a way that at least one lateral lip seals the deairing channel, and this is in such a way that a backflow is impossible. On the other side actually, if the lip seal is arranged in such a way that the side of the lip facing outwards projects in the deairing channel it is pushed away by the pressure coming from the armature space and thus makes deairing possible.

A solenoid, as described before, is characterised in a development in that the lip seal has an extending limb projecting in the deairing channel which takes over sealing on the side of the backflow. The extension is here provided angled in the direction of deairing so that at the same time it is achieved that, on the one hand, deairing can take place, and, on the other hand, however, a backflow is prevented.

It is preferred here that the lip seal is thickened like a wedge in the flow direction, and the thickening is slotted in the reverse direction of deairing, preferably slotted wedge-like. By means of that quasi seen in cross-section a wedge-shaped sealing element which is created as lip seal and which has a wedge-like recess so that one side of the thickening extends as limb and can act so to say as valve flap.

The invention suggests in another modification that the lip seal is arranged in a chamber of the deairing channel which holds the lip. This chamber is here, as described further above, provided in the coil form as well as also in the flange or the core depending on where the deairing channel passes.

Another aspect of the invention is given by the fact that the deairing channel is locked by a reservoir at whose side facing the deairing direction a boring is provided which ends in a conical running groove. In this groove then an O-ring is provided as locking element or the element preventing the backflow. Through the conical design of the groove it is possible that the O-ring can move in flow direction while the backflow movement is blocked by the conical design, and thus a return of air and/or oil or soilings is prevented completely.

The invention also provides a pressure control valve with at least one solenoid, as described before.

### BRIEF DESCRIPTION OF THE SEVERAL VIES OF THE DRAWINGS

The invention is described in the following by means of examples and drawings. In the drawings:

FIG. 1: a detailed view of a first embodiment of the invention;

FIG. 2: another detailed view of a further embodiment of the invention and

FIG. 3: a pressure control valve with solenoid according to the state of the art.

### DETAILED DESCRIPTION OF PREFERRED EMBODIMENTS

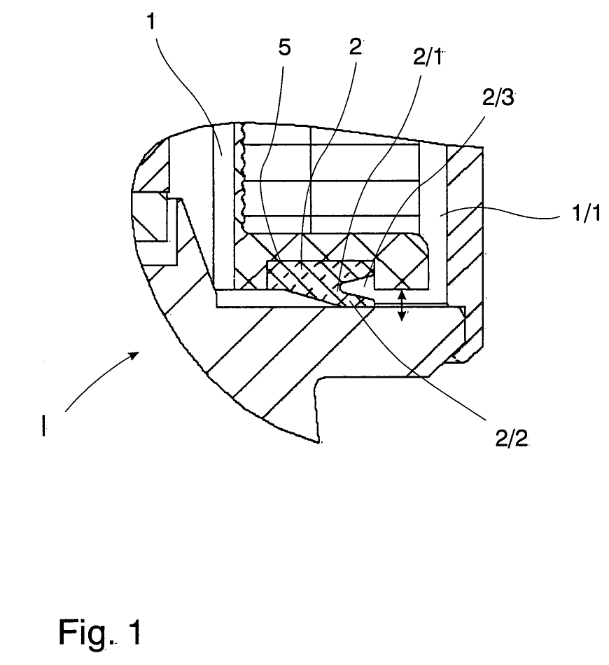

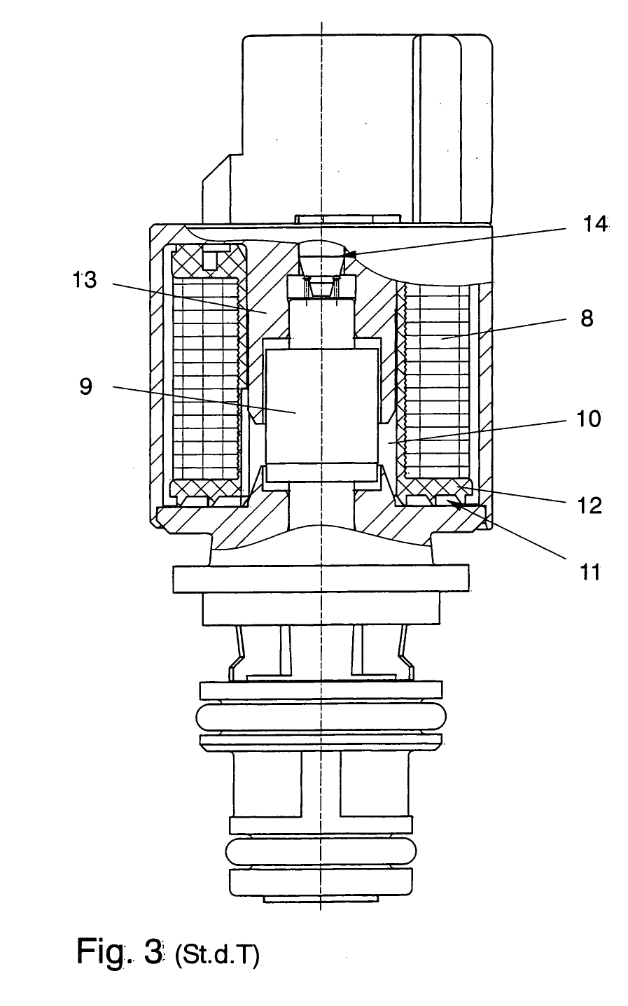

FIG. 1 shows a detailed view of a first embodiment of the invention. Here only the first section of the solenoid I is shown which is essential for the invention. The deairing channel is indicated here by 1. The side indicated by 1 (not shown here) faces the armature space 10 (see FIG. 3), and the side indicated by 1/1 of the deairing channel is on the side to deair.

In the deairing channel 1 in a chamber 5 a backflow-preventing element 2 designed as lip seal and permeable in the direction of deairing is provided. The backflow-preventing element 2 has here a thickening 2/1 running wedge-like in the direction of deairing. In opposite direction of deairing the element 2 is slotted 2/3 wedge-like on its underside or slotted 2/3 wedge-like in the direction of flow so that a limb 2/2 forms. This limb 2/2 acts quasi as valve flap. This is indicated with the double arrow on the right hand side beside the valve flap.

When now oil is filled in the armature space the air can escape via the deairing channel 1 as by the building pressure in the armature space then the limb 2/2 is pushed away inwards and thus the air can escape. If the armature space 10 is filled completely with oil no additional pressure is generated so that the limb 2/2 is moved back again in the position in contact with the wall of the deairing channel 1. If now from the side 1/1 of the deairing channel air and/or soilings approach these cannot get anymore in the armature space 10 as, because of the design of the lip seal, this is pushed when impinged with pressure from the side of the deairing channel 1/1 to the wall of the deairing channel so that the sealing effects improves. Air, oil or soilings cannot get in anymore from this side. This modification which can be got quite simply reduces the effort for filling armature spaces for solenoids with oil considerably. The solenoid I according to the invention is therefore not only suited as solenoid for pressure controllers but also for other solenoids which require in their armature space oil for lubricating and/or damping purposes.

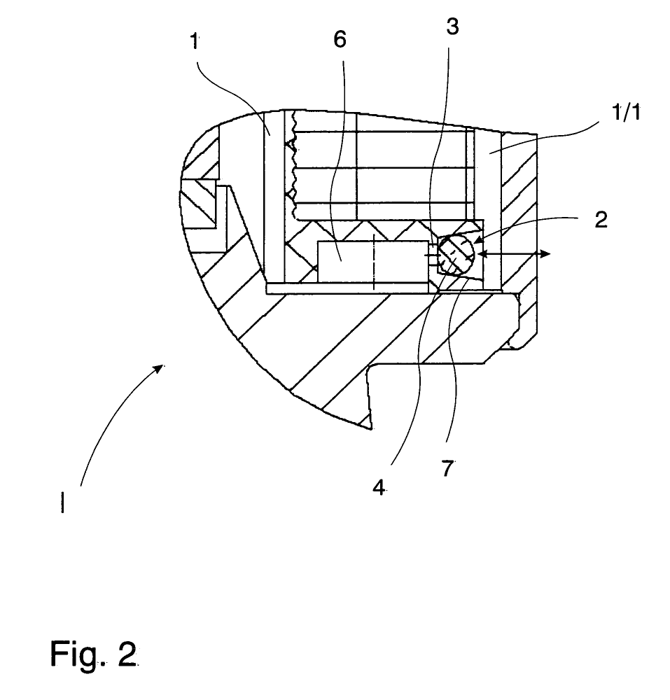

FIG. 2 shows another embodiment of the solenoid I according to the invention which is only indicated schematically with an arrow. In this embodiment the backflow-preventing element 2 is designed differently than in the illustration of FIG. 1 described before. In a reservoir 6 designed in the deairing channel 1 a boring 3 is provided. This boring 3 is here located in the bottom of the reservoir 6, that means in the direction to the outlet side 1/1 of the deairing channel. The backflow-preventing element 2 is designed in this embodiment as O-ring provided in a wedge-like groove 7 of the deairing channel on the side 1/1. The double arrow and at the side of the O-ring indicates that this can move to the right when impinged by pressure from the side 1/1 of the deairing channel. If there is pressure in the opposite direction from the side 1/1 of the deairing channel then the O-ring is pushed again towards the boring 3 and thus seals. The O-ring 4 is here arranged in the wedge-shaped groove 7 so that it is pushed during movement to the left towards the wall of the groove 7 and in this way also here, besides the terminal sealing at the boring 3, already here a sealing effect occurs.

FIG. 3 shows a solution according to the state of the art wherein it can be seen in this figure where the armature space 10 with the armature 9 is located. Below the coil form 8 a flange 12 is arranged. At the flange 12 an annular sealing is arranged spiral-like. Filling of the armature space 10 with oil should be carried out through the adjusting pin 14, wherein the air can escape through the flange 12 in a spiral-shaped sealing via the siphon space 11. The coil form 8 is surrounded at least partly, by the core 13.

Although the invention has been described in terms of specific embodiments which are set forth in condiserable detail, it should be understood that this is by way of illustration only and that the invention is not necessarily limited thereto, since alternative embodiments and operating techniques will become apparent to those skilled in that art in view of the disclosure. Accordingly, modifications are contemplated which can be made without departing from the spirit of the described invention.

1. Solenoid, in particular for switching pressure controllers or pressure valves, comprising an armature movable in an armature space and a coil which can be impinged by current, wherein the coil generates a magnetic field serving for the movement of the armature when impinged by current, and wherein the armature space can be filled with oil, and wherein for deairing the armature space at least one deairing channel is provided, characterised in that in the deairing channel (1) at least one element (2) is provided which is permeable in deairing direction and prevents backflow.

2. Solenoid according to claim 1, characterised in that the deairing channel (1) is part of the coil form (8) or is arranged in the coil form.

3. Solenoid according to claim 1, characterised in that the deairing channel (1) is provided on or in the flange (12) of the coil form (8) or in or at the siphon space (11).

4. Solenoid according to claim 1, characterised in that the deairing channel (1) is provided in the core (13).

5. Solenoid according to claim 1, characterised in that the backflow-preventing element (2) is provided in the coil form and/or the flange (12) and/or in the core (13).

6. Solenoid according to claim 1, characterised in that the backflow-preventing element (2) is provided as nonreturn valve.

7. Solenoid according to claim 1, characterised in that the backflow-preventing element (2) is designed as lip seal.

8. Solenoid according to claim 1, characterised in that the backflow-preventing element (2) is designed as lip seal and the lip seal has an extended limb (2/2) projecting in the deairing channel taking over the sealing on the side of the backflow.

9. Solenoid according to claim 1, characterised in that the backflow-preventing element (2) is designed as lip seal and the lip seal is thickening wedge-like in the direction of flow, and the thickening (2/1) is slotted, preferably slotted (2/3) wedge-like, opposite the direction of deairing.

10. Solenoid according to claim 1, characterised in that the backflow-preventing element (2) is designed as lip seal and the lip seal is arranged in a chamber (5) holding the sealing.

11. Solenoid according to claim 1, characterised in that the deairing channel (1) is locked by a reservoir (6) at whose side facing the deairing direction a boring (3) is provided which ends in a conical groove (7), and in the groove an O-ring (4) is provided as closing element or the backflow-preventing element (2).

12. Pressure control valve with at least one solenoid according to claim 1.
